(19) United States
(12) Patent Application Publication
(10) Pub. No.: US 2026/0299504 A1
(43) Pub. Date: Oct. 1, 2026

(54) ASSEMBLY MEMBER AND IMAGE FORMING APPARATUS

(71) Applicant: FUJIFILM Business Innovation Corp., Tokyo (JP)

(72) Inventor: Bokryong LEE, Kanagawa (JP)

(73) Assignee: FUJIFILM Business Innovation Corp., Tokyo (JP)

(21) Appl. No.: 19/307,240

(22) Filed: Aug. 22, 2025

(30) Foreign Application Priority Data
Mar. 26, 2025 (JP) 2025-052629

(51) Int. Cl. G03G 15/00; G03G 21/16

(52) U.S. Cl. CPC G03G 15/80; G03G 21/1647

(57) ABSTRACT

An assembly member includes: an assembly member body to be assembled with respect to an apparatus body; a wiring member extending from the assembly member body, to be routed in the apparatus body, and to be connected to a connecting portion of the apparatus body; and a winding portion around which the wiring member before being routed is wound along an accommodation path.

### CROSS-REFERENCE TO RELATED APPLICATIONS

This application is based on and claims priority under 35 USC 119 from Japanese Patent Application No. 2025-052629 filed Mar. 26, 2025.

### BACKGROUND

### (i) Technical Field

The present disclosure relates to an assembly member and an image forming apparatus.

### (ii) Related Art

Japanese Unexamined Patent Application Publication No. 2007-304199 discloses a technique relating to a fixing device and an image forming apparatus, such as a copying machine or a printer, including the fixing device, and particularly to a method of routing wires inside the fixing device. In this related art, a heating roller having a built-in heater and rotating clockwise is housed in an upper housing of the fixing device, and a pressure roller rotating counterclockwise is housed in a lower housing of the fixing device. The pressure roller is pressed against the heating roller with a predetermined pressure, and the two rollers constitute a fixing roller pair that fixes unfixed toner on a sheet passing through a fixing nip. A wiring path is provided in a space on the back surface side of a fixing entrance guide integrally formed with the lower housing, and a wire harness is wired along the wiring path.

Japanese Unexamined Patent Application Publication No. 2018-72629 discloses a technique relating to a connector holding mechanism that fixes a connector and an image forming apparatus including the connector holding mechanism. In this related art, a back plate holds a harness to which a body-side connector is connected. A connector unit fixes the body-side connector to the back plate. A slit is provided in the connector unit so as to allow the harness to pass therethrough when the body-side connector is fixed to the back plate via the connector unit. Shafts are provided on both sides of the slit in the connector unit and are used to fix the connector unit to the back plate.

Japanese Unexamined Patent Application Publication No. 2024-25873 discloses a technique relating to an image forming apparatus such as a printer, a copier, or a multifunction device. In this related art, the image forming apparatus includes a development drive support sheet metal on which a development motor used for image formation is mounted. The development drive support sheet metal is provided with a score serving as a mark for guiding a path along which a wire harness connected to the development motor is routed.

### SUMMARY

A wiring member such as a harness extending from an assembly member such as an assembly to be assembled with respect to an apparatus body may be in a hanging state until the wiring member is routed in the apparatus body and connected to a connecting portion such as a connector. The wiring member hanging down from the assembly member may hinder a task of assembling the assembly member or another assembly member with respect to the apparatus body.

Aspects of non-limiting embodiments of the present disclosure relate to preventing a wiring member before being connected to a connecting portion in an apparatus body from hanging from an assembly member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an assembly member including: an assembly member body to be assembled with respect to an apparatus body; a wiring member extending from the assembly member body, to be routed in the apparatus body, and to be connected to a connecting portion of the apparatus body; and a winding portion around which the wiring member before being routed is wound along an accommodation path.

### BRIEF DESCRIPTION OF THE DRAWINGS

Exemplary embodiment of the present disclosure will be described in detail based on the following figures, wherein:

FIG. 1 is a perspective view, as viewed from the front side, of an image forming apparatus according to an exemplary embodiment;

FIG. 2 is a perspective view, as viewed from the rear side, of the image forming apparatus according to the exemplary embodiment, in a state in which only an exterior cover on the rear side is not provided and a rear side part of an apparatus body is exposed;

FIG. 3 schematically illustrates the configuration of an image forming section of the apparatus body;

FIG. 4 is a perspective view of a motor assembly;

FIG. 5 is a perspective view of the motor assembly without a wire harness;

FIG. 6 is a perspective view of the rear side part of the apparatus body before the wire harness is routed;

FIG. 7 is a perspective view of the rear side part of the apparatus body after the wire harness is routed;

FIG. 8 is a rear view of the motor assembly without the wire harness, as viewed from the rear side of the apparatus;

FIG. 9 is a side view illustrating a state in which the motor assembly is assembled with respect to the rear side part;

FIG. 10 is a side view illustrating a state in which the motor assembly and a drive unit are assembled with respect to the rear side part;

FIG. 11 is a side view illustrating a state in which a motor assembly according to a comparative example is assembled with respect to the rear side part;

FIG. 12 is a side view illustrating a state in which the motor assembly and a drive unit according to the comparative example are assembled with respect to the rear side part; and

FIG. 13 is a perspective view of a motor assembly of another example.

### DETAILED DESCRIPTION

An image forming apparatus according to an exemplary embodiment of the present disclosure will be described with reference to the drawings.

Two horizontal directions orthogonal to each other are defined as the X and Y directions and are indicated by arrows X and Y, respectively. A vertical direction orthogonal to the X and Y directions is defined as the Z direction and is indicated by arrow Z. The X direction corresponds to the front-rear direction of the apparatus, and the Y direction corresponds to the width direction of the apparatus. Arrow F indicates the front side in the front-rear direction of the apparatus, and arrow R indicates the rear side in the front-rear direction of the apparatus.

The drawings are schematic. The dimensions, ratios, and the like of the elements illustrated in the drawings do not necessarily reflect the actual measurements. The dimensions, ratios, numbers, and the like of the respective elements do not necessarily match across multiple drawings. Hatching indicating a cross section is omitted when it makes the drawing difficult to view.

In addition, the descriptions of the configurations that are not directly related to the present disclosure, well-known configurations, and the like may be omitted or simplified.

### Schematic Configuration of Image Forming Apparatus

First, a schematic configuration of an image forming apparatus will be described.

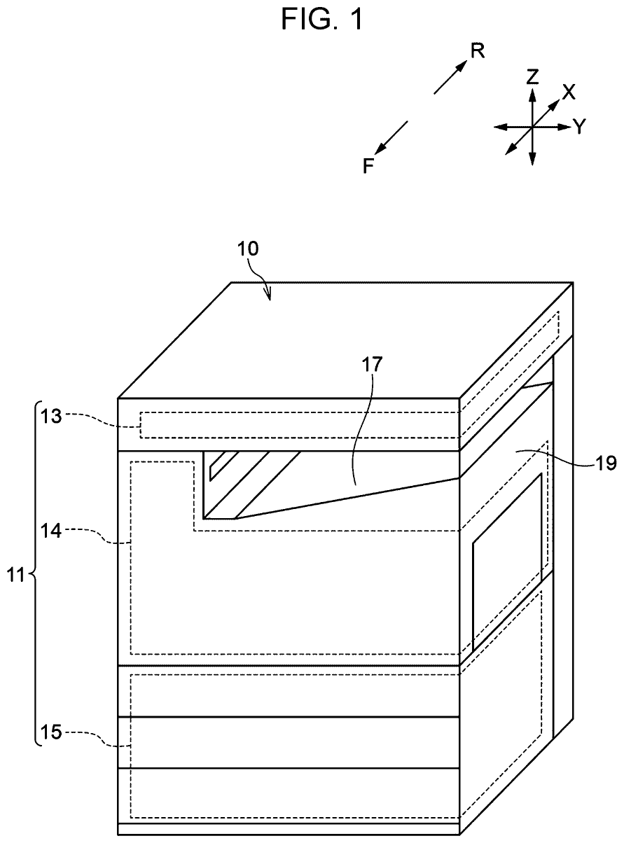

An image forming apparatus 10, serving as an example of an apparatus according to this exemplary embodiment, illustrated in FIG. 1, is a so-called multifunction device having functions of a printer, a copier, a facsimile machine, a scanner, and the like, but is not limited thereto.

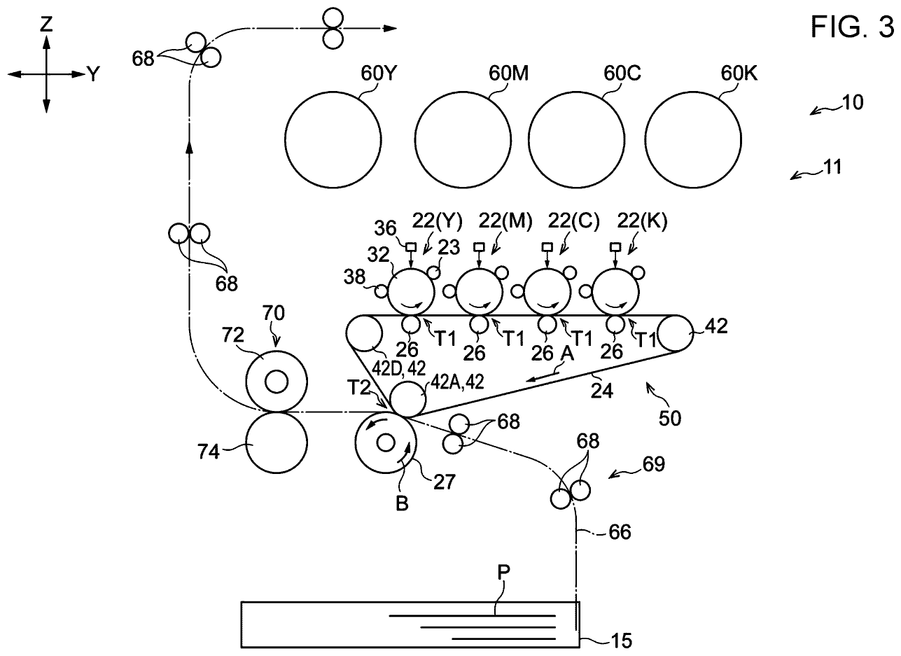

The image forming apparatus 10 has an apparatus body 11 in which a reading unit 13, an image forming section 14, and a storage unit 15 are provided. The apparatus body 11 is covered with an exterior cover 19 made of resin. The reading unit 13 is disposed at the upper part of the image forming apparatus 10, the image forming section 14 is disposed below the reading unit 13, and the storage unit 15 is disposed in the lower part of the image forming apparatus 10. Sheet materials P (see FIG. 3) such as paper are stored in the storage unit 15, and a sheet material P is fed from the storage unit 15 to the image forming section 14, where an image is formed. A discharging part 17, to which a sheet material P such as paper having an image formed in the image forming section 14 is discharged, is provided between the reading unit 13 and the image forming section 14 of the image forming apparatus 10.

### Image Forming Section

The image forming section 14 illustrated in FIG. 3 forms a toner image, which is an example of a developer image, on a sheet material P such as paper with an electrophotographic method. The image forming section 14 includes toner image forming units 22, a transfer unit 50, a fixing device 70, and a transport mechanism 69.

### Toner Image Forming Unit

The toner image forming units 22, which are an example of developer image forming units, form toner images. There are multiple toner image forming units 22 that form toner images corresponding to the respective colors. In this exemplary embodiment, the toner image forming units 22 corresponding to four colors, namely, yellow (Y), magenta (M), cyan (C), and black (K) are provided. In FIG. 1, (Y), (M), (C), and (K) represent components corresponding to the respective colors.

Because the toner image forming units 22 corresponding to the respective colors have the same structure except for the toner used, the components of the toner image forming unit 22(Y), which represents the toner image forming units 22 corresponding to the respective colors, are denoted by reference signs in FIG. 3.

The toner image forming units 22 corresponding to the respective colors each include a charger 23, an exposure device 36, and a developing device 38. A photoconductor drum 32 rotates in one direction, that is, in the counterclockwise direction in FIG. 3.

In each of the toner image forming units 22 corresponding to the respective colors, first, the charger 23 charges the photoconductor drum 32. Next, the exposure device 36 irradiates the photoconductor drum 32, which has been charged by the charger 23, with light to form an electrostatic latent image on the photoconductor drum 32. Next, the developing device 38 develops the electrostatic latent image, which has been formed on the photoconductor drum 32 by the exposure device 36, to form a toner image.

The toner image forming units 22 include developer cartridges 60Y, 60M, 60C, and 60K for supplying the developer to the corresponding developing devices 38. The developer cartridges 60 corresponding to the respective colors supply toners of the respective colors to the corresponding developing devices 38 via supply paths (not illustrated). The developer cartridges 60 corresponding to the respective colors are arranged side by side in the apparatus width direction, above the exposure devices 36, and are individually attachable to and detachable from the apparatus body 11. The developer cartridges 60 corresponding to the respective colors have drive mechanisms (not illustrated) that rotationally drive paddles or the like for supplying the developer to the developing devices 38.

### Transfer Unit

The transfer unit 50 transfers the toner images formed by the toner image forming units 22 to a sheet material P. The transfer unit 50 includes an intermediate transfer belt 24, first transfer rollers 26, a second transfer roller 27, and an opposing roller 42A. In the transfer unit 50, toner images on the photoconductor drums 32 corresponding to the respective colors are first-transferred in a superimposed manner to the intermediate transfer belt 24, which is an example of an intermediate transfer body, and the superimposed toner image is second-transferred to the sheet material P at a second transfer position T2.

### First Transfer Roller

The first transfer rollers 26 transfer the toner images on the photoconductor drums 32 corresponding to the respective colors to the intermediate transfer belt 24 at first transfer positions T1 between the photoconductor drums 32 and the first transfer rollers 26. In this exemplary embodiment, first transfer electric fields are applied between the first transfer rollers 26 and the photoconductor drums 32, so that the toner images formed on the photoconductor drums 32 are transferred to the intermediate transfer belt 24 at the first transfer positions T1.

### Intermediate Transfer Belt

The toner images are transferred from the photoconductor drums 32 corresponding to the respective colors to the outer circumferential surface of the intermediate transfer belt 24. The intermediate transfer belt 24 has a loop shape. The intermediate transfer belt 24 is wound around multiple rollers 42 including a driving roller 42D and the opposing roller 42A and is held in position. The intermediate transfer belt 24 is driven in a predetermined direction indicated by arrow A when, for example, the driving roller 42D, among the rollers 42, is rotationally driven.

### Second Transfer Roller and Opposing Roller

The second transfer roller 27 transfers the toner image to the sheet material P. The second transfer roller 27 is rotationally driven in the direction of arrow B.

The second transfer roller 27 and the opposing roller 42A are disposed so as to face each other with the intermediate transfer belt 24 therebetween. In this exemplary embodiment, a position between the second transfer roller 27 and the opposing roller 42A is a second transfer position T2, at which the toner image is transferred from the intermediate transfer belt 24 to the sheet material P. When a second transfer electric field is applied between the second transfer roller 27 and the opposing roller 42A, the toner images that have been first-transferred to the intermediate transfer belt 24 are second-transferred to the sheet material P at the second transfer position T2.

### Fixing Device

The fixing device 70 fixes the toner image transferred to the sheet material P. The fixing device 70 includes a heating roller 72 and a pressure roller 74. The heating roller 72 and the pressure roller 74 nip the sheet material P and apply heat and pressure to the toner image to fix the toner image to the sheet material P.

### Transport Mechanism

The transport mechanism 69 includes multiple pairs of transport rollers 68, transports, along a transport path 66, the sheet material P transported from the storage unit 15 (see also FIG. 1), and discharges the sheet material P to the discharging part 17 (see FIG. 1).

### Image Forming Operation

Next, an overview of a basic image forming operation performed on a sheet material P by the image forming apparatus 10 will be described.

Various operations of the image forming apparatus 10 are performed by a controller (not illustrated) incorporated in the apparatus. Upon receipt of an image formation command from the outside, the controller operates the toner image forming units 22. The photoconductor drums 32 corresponding to the respective colors are charged by the chargers 23 while rotating. The controller transmits, to the exposure devices 36, the image data that has undergone image processing. The exposure devices 36 irradiate the photoconductor drums 32 with exposure light according to the image data to expose the charged photoconductor drums 32 to light. As a result, electrostatic latent images are formed on the outer circumferential surfaces of the photoconductor drums 32. The electrostatic latent images formed on the photoconductor drums 32 are developed by the developing devices 38, and toner images of the respective colors are formed on the outer circumferential surfaces of the photoconductor drums 32 corresponding to the respective colors.

The toner images formed on the photoconductor drums 32 corresponding to the respective colors are first-transferred to the intermediate transfer belt 24 by the first transfer rollers 26 corresponding to the respective colors at the first transfer positions T1. At this time, because the intermediate transfer belt 24 is running, the toner images corresponding to the respective colors are sequentially first-transferred to the intermediate transfer belt 24 in a superimposed manner. The superimposed toner image is transported to the second transfer position T2 as the intermediate transfer belt 24 runs. The superimposed toner image is transferred from the intermediate transfer belt 24 to a sheet material P at the second transfer position T2.

The sheet material P to which the toner image has been second-transferred is transported to the fixing device 70. The sheet material P is subjected to heat and pressure in the fixing device 70, and the toner image is fixed. The sheet material P to which the toner image has been fixed is discharged to the discharging part 17.

### Rear Side Part

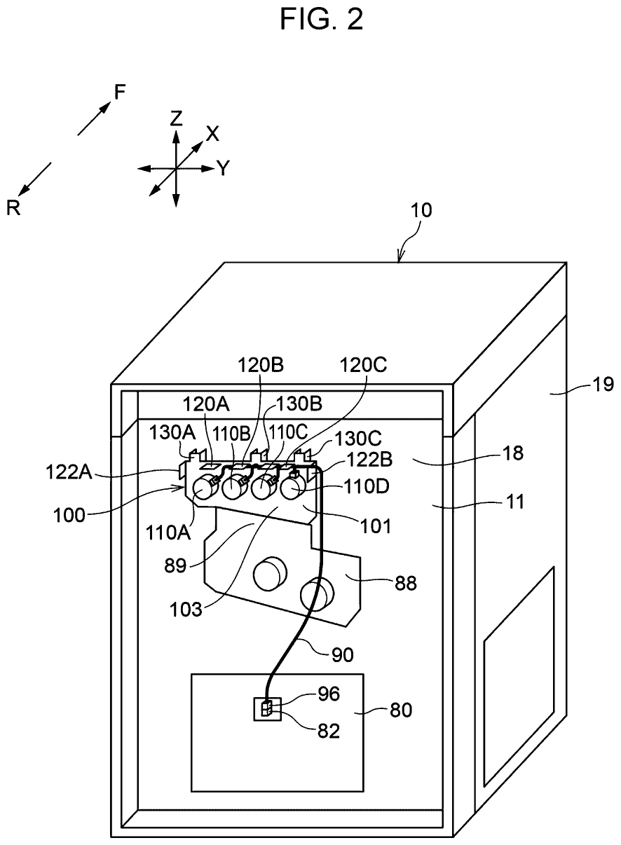

As illustrated in FIG. 2, an apparatus electric board, an assembly, a unit, and the like are provided on a rear side part 18 of the apparatus body 11 of the image forming apparatus 10. Note that FIG. 2 is a perspective view illustrating a state in which only the exterior cover 19 on the rear side is not provided, and the rear side part 18 of the apparatus body 11 is exposed. Although there are multiple electric boards, assemblies, units, and the like on the rear side part 18, only a drive unit 88, a motor assembly 100, and an electric board 80 are illustrated in FIG. 2, and the other components are omitted.

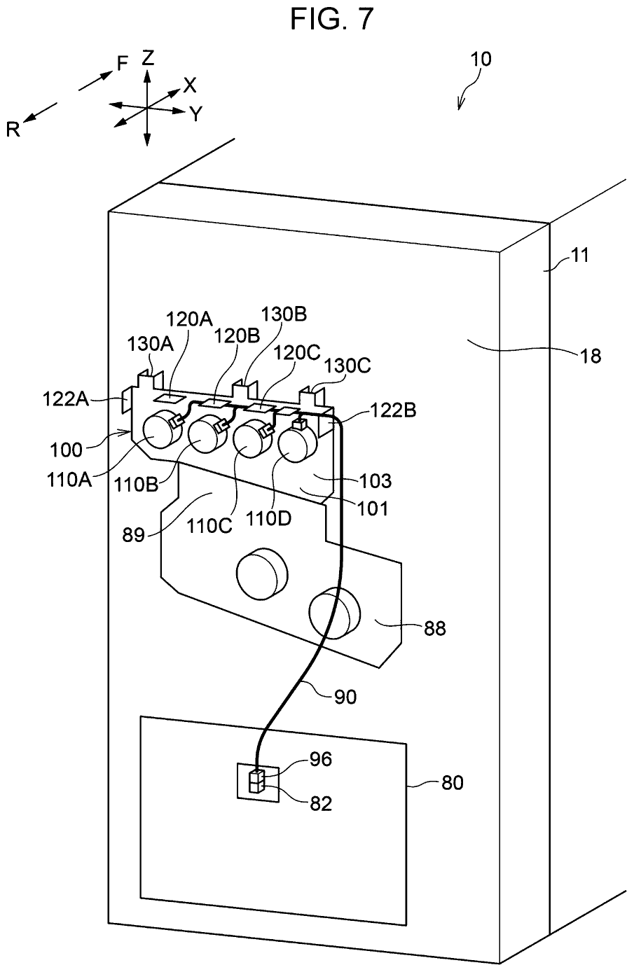

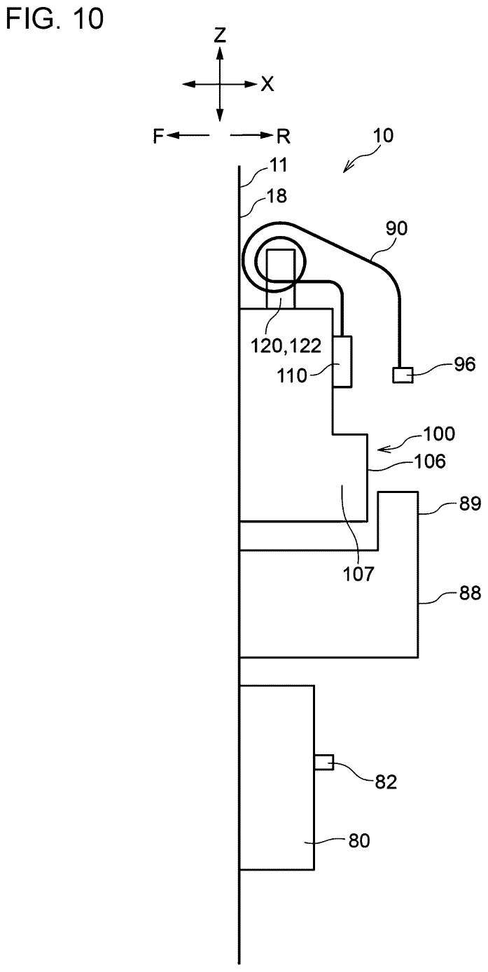

In this exemplary embodiment, an upper end 89 of the drive unit 88 is disposed on the rear side of a lower end 101 of the motor assembly 100 (also see FIGS. 7 and 10). A wire harness 90, which is an example of a wiring member, extending from the motor assembly 100 is routed over the rear side of the drive unit 88, and a connector 96 at the distal end of the wire harness 90 is connected to a connector 82 of the electric board 80 (also see FIG. 7).

### Motor Assembly

Next, the motor assembly 100, which is an example of an assembly member, will be described. The directions regarding the motor assembly 100 will be described based on a state in which the motor assembly 100 is assembled with respect to the apparatus body 11.

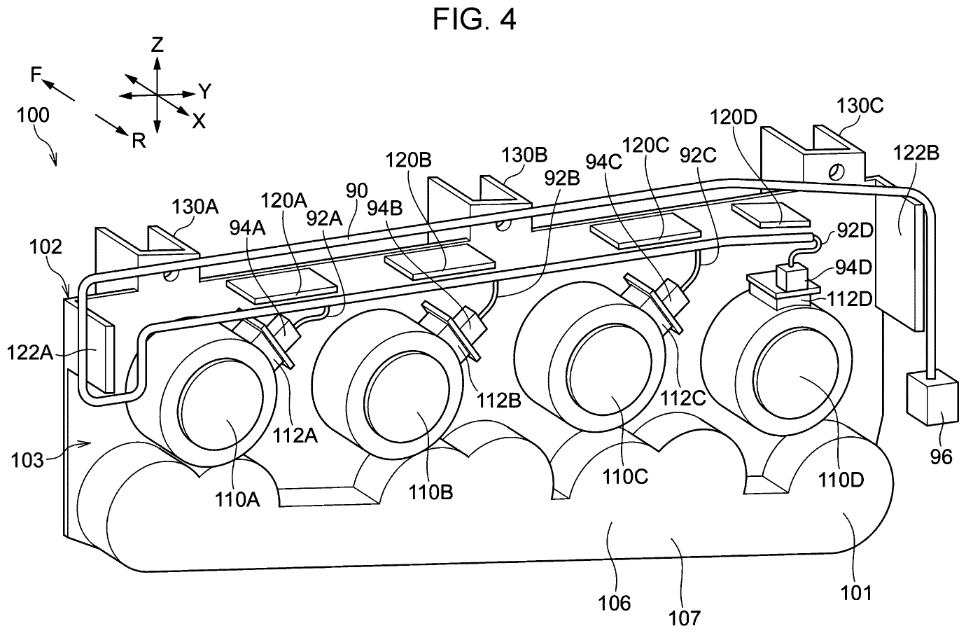

As illustrated in FIG. 4, the motor assembly 100 includes an assembly body 103, the wire harness 90, winding portions 120A, 120B, 120C, 120D, 122A, and 122B, and partition portions 130A, 130B, and 130C. The assembly body 103 is an example of an assembly member body.

As illustrated in FIGS. 4, 5 and 8, the motor assembly 100 includes a housing 102 and four motors 110A, 110B, 110C, and 110D fixed to the housing 102. The motors 110A, 110B, 110C, and 110D are provided corresponding to the developer cartridges 60Y, 60M, 60C, and 60K (see FIG. 3) described above, and drive the drive mechanisms (not illustrated) for rotationally driving the paddles or the like. When the motors 110A, 110B, 110C, and 110D do not need to be distinguished from one another, the motors may be referred to as the motors 110 without A, B, C, or D affixed to the reference signs.

The four motors 110 are fixed to the housing 102 so as to protrude rearward. A protruding portion 107 that forms a step protruding rearward as a whole is formed below the portion where the four motors 110 are attached, on the rear side of the housing 102. The rear surface of the protruding portion 107 is referred to as a protruding surface 106.

Connectors 112A, 112B, 112C, and 112D are provided at the upper parts of the four motors 110. Multiple plate-like winding portions 120A, 120B, 120C, and 120D protruding rearward are formed above the connectors 112A, 112B, 112C, and 112D, respectively, at the upper end of the outer peripheral portion of the housing 102. A plate-like winding portion 122A protruding rearward is formed on the outer peripheral portion of the housing 102, to the left of the connector 112A in FIG. 4. Similarly, a plate-like winding portion 122B protruding rearward is formed to the right of the connector 112D in FIG. 4. The winding portions 120A, 120B, 120C, 120D, 122A, and 122B are made of a resin material that satisfies the fire enclosure standards.

When the connectors 112A, 112B, 112C, and 112D do not need to be distinguished from one another, the connectors may be referred to as the connectors 112 without A, B, C, or D affixed to the reference signs. In addition, when the winding portions 120A, 120B, 120C, and 120D do not need to be distinguished from one another, the winding portions may be referred to as the winding portions 120 without A, B, C, or D affixed to the reference signs. Similarly, when the winding portions 122A and 122B do not need to be distinguished from each other, the winding portions may be referred to as the winding portions 122 without A or B affixed to the reference signs.

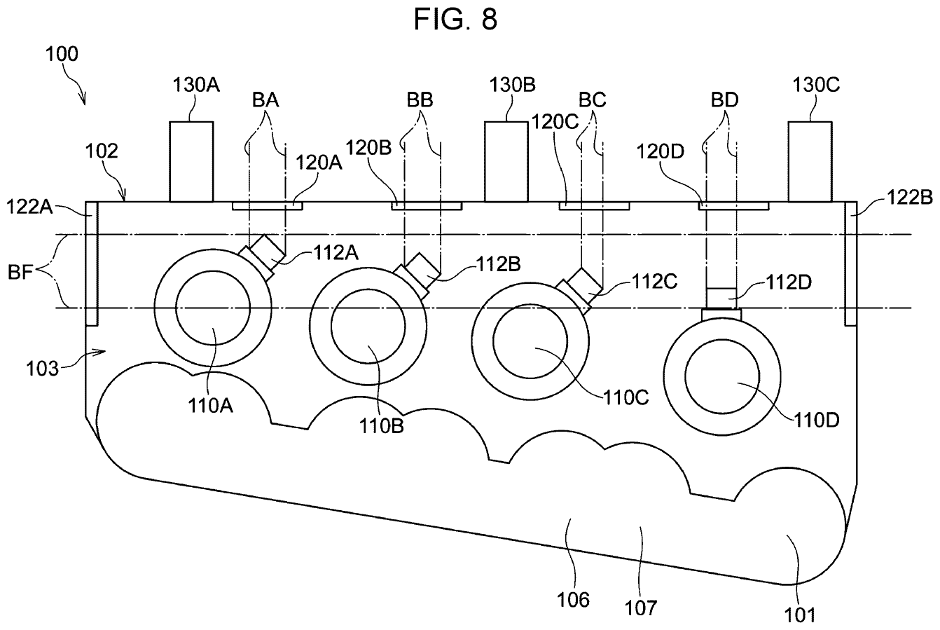

As illustrated in FIG. 8, the projection area above the connector 112A is BA, and the projection area above the connector 112B is BB. Similarly, the projection area above the connector 112C is BC, and the projection area above the connector 112D is BD. The winding portions 120A, 120B, 120C, and 120D are provided so as to overlap the projection areas BA, BB, BC, and BD, respectively. The projection area of the connectors 112A, 112B, 112C, and 112D in the Y direction is BF. The winding portions 122A and 122B are provided so as to overlap the projection area BF.

When the projection areas BA, BB, BC, BD, and BF do not need to be distinguished from one another, the projection areas may be referred to as the projection areas B without A, B, C, D, or F affixed to the reference signs.

As illustrated in FIGS. 4, 5, and 8, the partition portions 130A, 130B, and 130C protruding upward and forward are formed at the upper end of the outer peripheral portion of the housing 102. The partition portions 130A, 130B, and 130C have a groove shape in plan view. When the partition portions 130A, 130B, and 130C do not need to be distinguished from one another, the partition portions may be referred to as the partition portions 130 without A, B, or C affixed to the reference signs.

Terminals 94A, 94B, 94C, and 94D provided at the distal ends of four wires 92A, 92B, 92C, and 92D, respectively, which constitute the wire harness 90, are connected to the connectors 112 of the four motors 110.

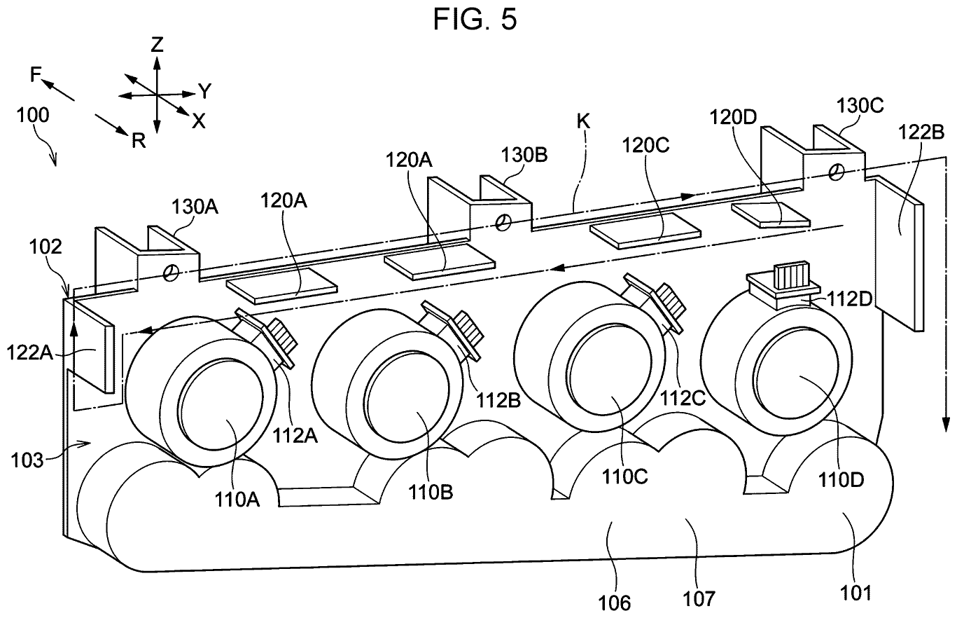

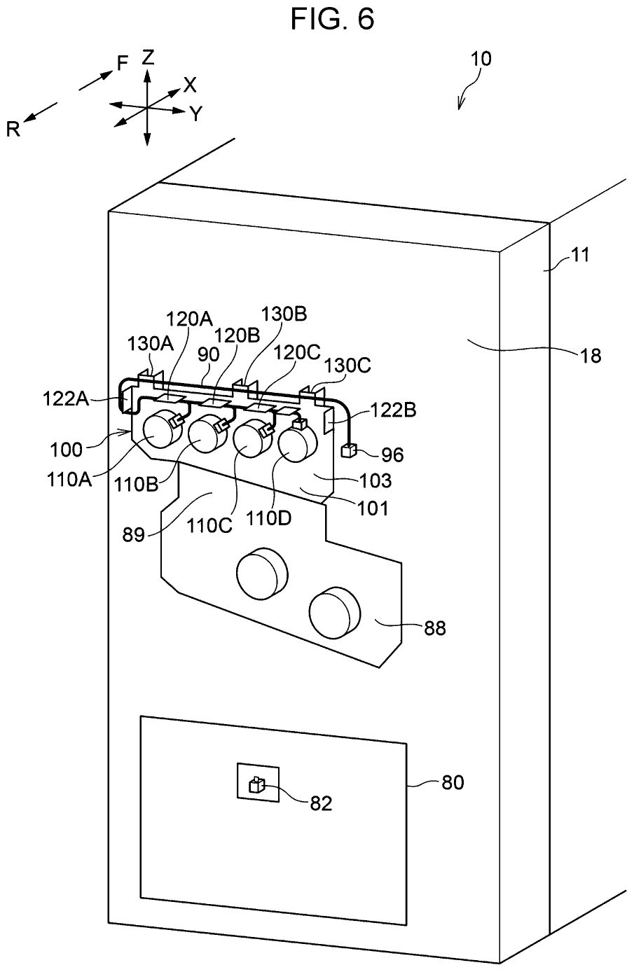

As illustrated in FIG. 4, the wire harness 90 before being routed and connected to the connector 82 (see FIGS. 2 and 7) of the electric board 80 is wound around the winding portions 120 and 122 and is accommodated and temporarily held (see also FIG. 6). A path in which the wire harness 90 before being routed and wound around the winding portions 120 and 122 is accommodated is referred to as an accommodation path K (see FIG. 5).

In other words, the wire harness 90 before being routed is wound around the winding portions 120 and 122 along the accommodation path K. The winding portions 120A, 120B, 120C, 120D, 122A, and 122B are provided at intervals along the accommodation path K (see FIG. 5).

In FIG. 4 and other drawings, there is a gap between the upper surfaces of the winding portions 120 and 122 and the wire harness 90. This is for ease of understanding, and, in actuality, the wire harness 90 is in contact with the upper surfaces of the winding portions 120 and 122.

### Process of Assembling Motor Assembly

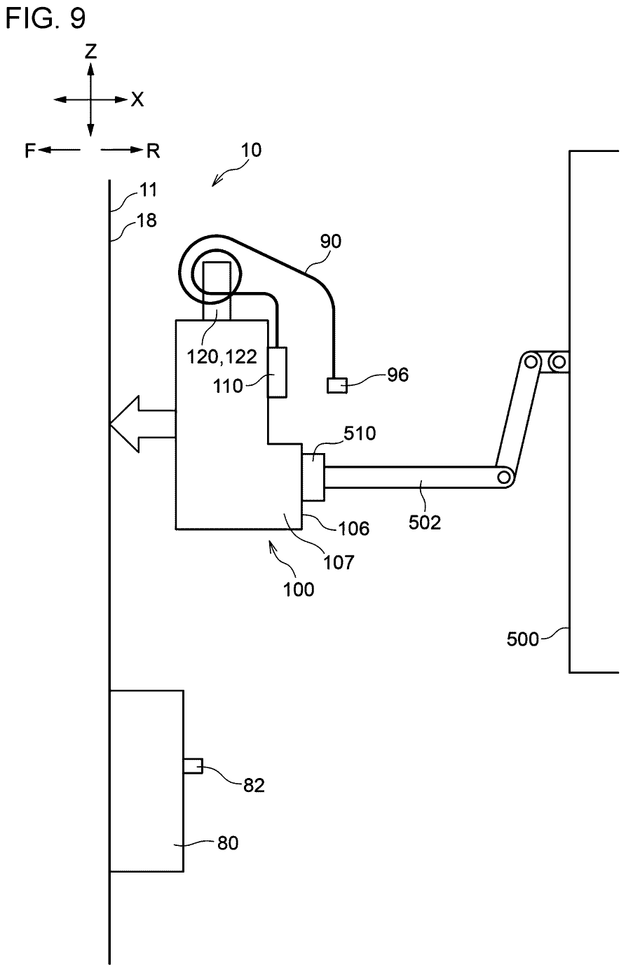

Next, a process of assembling the motor assembly 100 with respect to the rear side part 1 of the apparatus body 11 of the image forming apparatus 10 will be described. In this exemplary embodiment, the motor assembly 100 is assembled with respect to the rear side part 18 by an industrial robot 500, as described above (see FIG. 9).

As illustrated in FIG. 4, the motor assembly 100 before being assembled with respect to the rear side part 18 is transported in a state in which the wire harness 90 is wound around the winding portions 120 and 122 along the accommodation path K (see FIG. 5) and temporarily held.

In FIGS. 9 and 10 to be used in the following description, the components are schematically illustrated for ease of understanding. Thus, the winding portions 120 and 122A (see FIG. 4) and how the wire harness 90 is wound around the winding portions are different from those in actuality.

As illustrated in FIG. 9, the industrial robot 500 holds, with a suction part 510 at the distal end of an arm 502, the protruding surface 106 of the motor assembly 100 in which the wire harness 90 is wound around the winding portions 120 and 122 along the accommodation path K (see FIG. 5) and is temporarily held. Then, the industrial robot 500 assembles the motor assembly 100 with respect to the rear side part 18.

As illustrated in FIGS. 6 and 10, the industrial robot 500 (see FIG. 9) holds the drive unit 88 and assembles the drive unit 88 with respect to the rear side part 18, below the motor assembly 100.

As illustrated in FIGS. 2 and 7, an operator (not illustrated) removes the wire harness 90 of the motor assembly 100 from the winding portions 120 and 122, routes the wire harness 90, and connects the connector 96 of the wire harness 90 to the connector 82 of the electric board 80.

### Operation

Next, the operation of this exemplary embodiment will be described.

As illustrated in, for example, FIGS. 4, 9, and 10, the wire harness 90 of the motor assembly 100 is wound around the winding portions 120 and 122 and is accommodated and temporarily held.

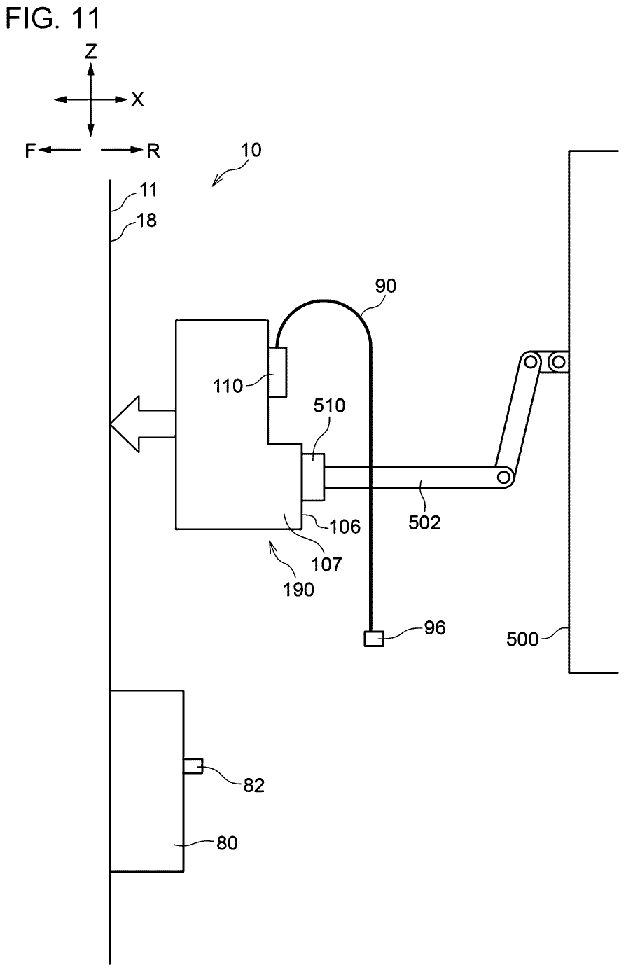

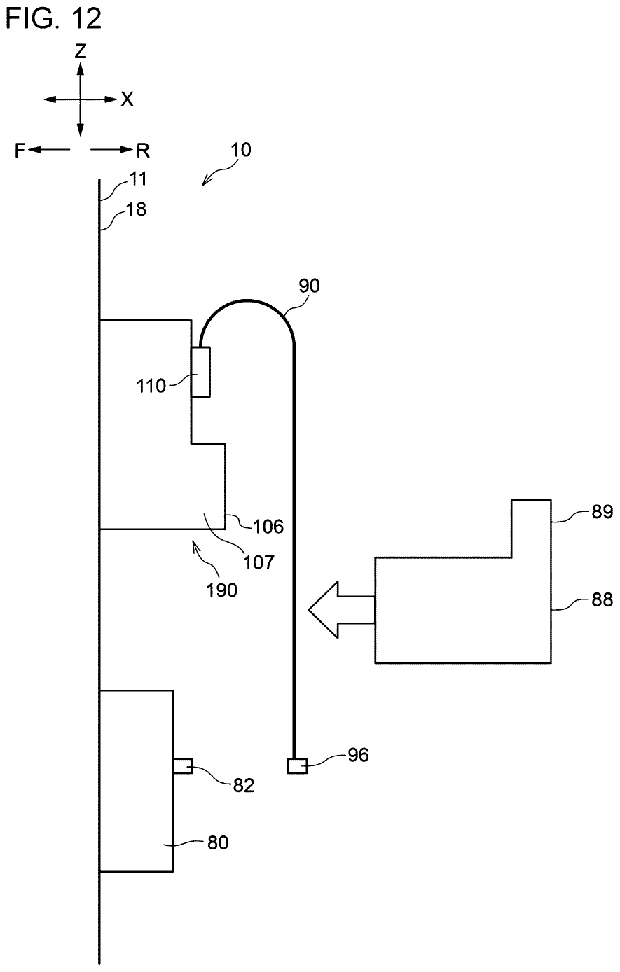

A motor assembly 190 according to a comparative example illustrated in FIGS. 11 and 12 will be described below.

The motor assembly 190 according to the comparative example illustrated in FIGS. 11 and 12 does not have the winding portions 120 or 122. Thus, the wire harness 90 of the motor assembly 190 according to the comparative example before being assembled with respect to the rear side part hangs down from the motor assembly 190.

Thus, as illustrated in FIG. 11, the wire harness 90 might get entangled with the arm 502 of the industrial robot 500 during assembly. Furthermore, the wire harness 90 may be caught between the suction part 510 at the distal end of the arm 502 and the protruding surface 106. Thus, with the motor assembly 190 according to the comparative example, the wire harness 90 may hinder the task of assembling the motor assembly 190 with respect to the rear side part 18 of the apparatus body 11.

Furthermore, as illustrated in FIG. 12, the wire harness 90 may hinder the task of assembling the drive unit 88 with respect to the rear side part 18 of the apparatus body 11. Thus, with the motor assembly 190 according to the comparative example, the wire harness 90 may hinder the task of assembling another assembly member, such as the drive unit 88, with respect to the rear side part 18 of the apparatus body 11.

In contrast, as illustrated in, for example, FIGS. 4, 9, and 10, with the motor assembly 100 according to this exemplary embodiment, the wire harness 90 is wound around the winding portions 120 and 122 and is accommodated and temporarily held.

Thus, the wire harness 90 of the motor assembly 100 before being assembled with respect to the rear side part does not hang down from the motor assembly 100.

As illustrated in FIGS. 4 and 9, the accommodation path K (see FIG. 5) for the wire harness 90 of the motor assembly 100 is set so as not to overlap the protruding surface 106, which is a holding region to be held by the industrial robot 500 (see FIG. 9) when the motor assembly 100 is assembled with respect to the apparatus body 11.

As illustrated in FIG. 8, the winding portions 120 and 122 are provided so as to overlap the projection areas B of the connectors 112.

The connectors 112 may be a source of fire, so, the connectors 112 need to be surrounded by fire enclosures on six sides thereof, specifically, both sides in each of the X, Y, and Z directions. When the exterior cover 19 (see FIG. 1) serves as a fire enclosure, there is no need to provide a fire enclosure member for each of the connectors 112.

However, for example, if the resin material of the exterior cover 19 (see FIG. 1) does not satisfy the fire enclosure standards in order to comply with the chemical substance regulation for improving the ratio of the recycled material, fire enclosure members for the connectors 112 need to be separately provided.

In this exemplary embodiment, the winding portions 120 and 122 are formed of a resin material that satisfies the fire enclosure standards. The winding portions 120 and 122 are provided so as to overlap the projection areas B of the connectors 112. Thus, the winding portions 120 and 122 also serve as fire enclosure members.

As illustrated in FIGS. 4 and 5, the partition portions 130 are provided on the side of the motor assembly 100 opposite from the accommodation path K (see FIG. 5) for the wire harness 90, the side facing the rear side part 18 of the apparatus body 11.

### Modification

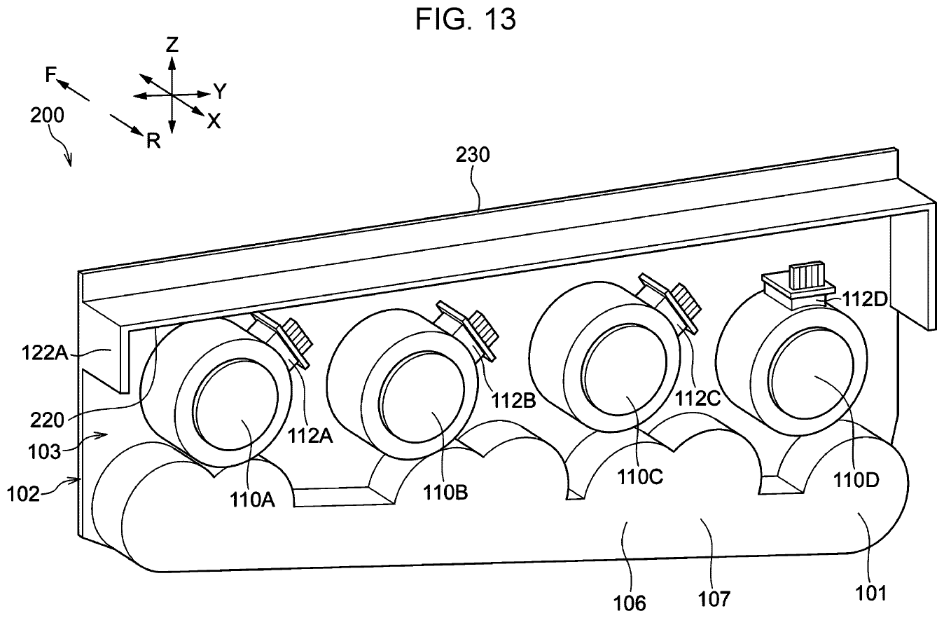

Next, a motor assembly 200 according to a modification illustrated in FIG. 13 will be described.

In the motor assembly 200 according to the modification, an inverted U-shaped plate-like winding portion 220 protruding rearward is formed along the accommodation path K (see FIG. 5), on the upper end and the side ends in the Y direction of the outer peripheral portion of the housing 102. A single plate-like partition portion 230 projecting upward is formed on the upper end of the outer peripheral portion of the housing 102. In this modification, the winding portion 220 is made of a resin material that satisfies the fire enclosure standards.

Because the winding portion 220 continuously covers the top and the sides of the connectors 112 in this manner, the winding portion 220 more effectively encloses fire than the configuration in which multiple winding portions 120 and 122 are formed at intervals (see FIG. 4, etc.).

Furthermore, because the partition portion 230 is a single plate-like member, the wire harness 90 is more reliably prevented from going toward the rear side part 18 than in the configuration in which multiple partition portions 130 are formed at intervals (see, for example, FIG. 4).

The material cost is lower in the configuration in which the multiple winding portions 120 and 122 are formed at intervals as in the configuration illustrated in FIG. 4 than in the configuration in which the winding portion 220 continuously covers the top and the sides of the connectors 112 (see FIG. 13).

Similarly, the material cost is lower in the configuration in which the multiple partition portions 130 are formed at intervals as in the configuration of FIG. 4 than in the configuration in which the single partition portion 230 is formed (see FIG. 13).

### Others

The present disclosure is not limited to the above-described exemplary embodiment.

For example, the winding portions 120, 122, and 220 of the above-described exemplary embodiment and the modification are merely examples and are not intended to be exhaustive. The shape of the winding portions may be appropriately designed according to the length, thickness, and the like of the wire harness. The number of turns of the wire harness wound around the winding portions is not limited, and may be two or more.

For example, in the above-described exemplary embodiment, the industrial robot 500 assembles the motor assembly 100 with respect to the apparatus body 11, but the present disclosure is not limited thereto. An operator may hold the protruding portion 107 or the like of the motor assembly 100 and assemble the motor assembly 100 with respect to the apparatus body 11.

Furthermore, the present disclosure may be implemented in various modes without departing from the gist of the present disclosure. Multiple exemplary embodiments, modifications, and the like may be implemented in combination as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An assembly member to be assembled with respect to an apparatus body, comprising:
a wiring member to be routed in the apparatus body and connected to a connecting portion of the apparatus body; and
a winding portion around which the wiring member before being routed is wound along an accommodation path.
(((2)))

The assembly member according to (((1))), wherein the accommodation path is set so as not to overlap a holding region to be held by an industrial robot or an assembly worker when the assembly member is assembled with respect to the apparatus body.
(((3)))

The assembly member according to (((1))) or (((2))), wherein the winding portion includes a plurality of winding portions, and the plurality of winding portions are provided at intervals along the accommodation path.
(((4)))

The assembly member according to any one of (((1))) to (((3))), wherein the winding portion overlaps a projection area of a source of fire.
(((5)))

The assembly member according to (((4))), wherein the source of fire is a connector to which the wiring member is connected.
(((6)))

The assembly member according to any one of (((1))) to (((5))), further comprising a partition portion on a side of the assembly member opposite from the accommodation path for the wiring member, the side facing an apparatus body.
(((7)))

The assembly member according to (((6))), wherein the partition portion includes a plurality of partition portions, and the plurality of partition portions are provided at intervals along the accommodation path.
(((8)))

An image forming apparatus comprising: an apparatus body with respect to which the assembly member according to any one of (((1))) to (((7))) is assembled; and
a wiring member extending from the assembly member, routed in the apparatus body, and connected to a connecting portion of the apparatus body.
(((9)))

An assembly member comprising: an assembly member body to be assembled with respect to an apparatus body;
a wiring member to be routed in the apparatus body and to be connected to a connecting portion; and
a winding portion around which the wiring member is wound.

What is claimed is:

1. An assembly member comprising:
an assembly member body to be assembled with respect to an apparatus body;
a wiring member extending from the assembly member body, to be routed in the apparatus body, and to be connected to a connecting portion of the apparatus body; and
a winding portion around which the wiring member before being routed is wound along an accommodation path.

2. The assembly member according to claim 1, wherein the accommodation path is set so as not to overlap a holding region to be held by an industrial robot or an assembly worker when the assembly member is assembled with respect to the apparatus body.

3. The assembly member according to claim 1, wherein the winding portion includes a plurality of winding portions, and the plurality of winding portions are provided at intervals along the accommodation path.

4. The assembly member according to claim 1, wherein the winding portion overlaps a projection area of a source of fire.

5. The assembly member according to claim 4, wherein the source of fire is a connector to which the wiring member is connected.

6. The assembly member according to claim 1, further comprising a partition portion on a side of the assembly member opposite from the accommodation path for the wiring member, the side facing an apparatus body.

7. The assembly member according to claim 6, wherein the partition portion includes a plurality of partition portions, and the plurality of partition portions are provided at intervals along the accommodation path.

8. An image forming apparatus comprising:
an apparatus body with respect to which the assembly member according to claim 1 is assembled; and
a wiring member extending from the assembly member, routed in the apparatus body, and connected to a connecting portion of the apparatus body.

9. An image forming apparatus comprising:
an apparatus body with respect to which the assembly member according to claim 2 is assembled; and
a wiring member extending from the assembly member, routed in the apparatus body, and connected to a connecting portion of the apparatus body.

10. An image forming apparatus comprising:
an apparatus body with respect to which the assembly member according to claim 3 is assembled; and
a wiring member extending from the assembly member, routed in the apparatus body, and connected to a connecting portion of the apparatus body.

11. An image forming apparatus comprising:
an apparatus body with respect to which the assembly member according to claim 4 is assembled; and
a wiring member extending from the assembly member, routed in the apparatus body, and connected to a connecting portion of the apparatus body.

12. An image forming apparatus comprising:
an apparatus body with respect to which the assembly member according to claim 5 is assembled; and
a wiring member extending from the assembly member, routed in the apparatus body, and connected to a connecting portion of the apparatus body.

13. An image forming apparatus comprising:
an apparatus body with respect to which the assembly member according to claim 6 is assembled; and
a wiring member extending from the assembly member, routed in the apparatus body, and connected to a connecting portion of the apparatus body.

14. An image forming apparatus comprising:
an apparatus body with respect to which the assembly member according to claim 7 is assembled; and
a wiring member extending from the assembly member, routed in the apparatus body, and connected to a connecting portion of the apparatus body.

15. An assembly member comprising:
an assembly member body to be assembled with respect to an apparatus body;
a wiring member extending from the assembly member body, to be routed in the apparatus body, and to be connected to a connecting portion; and
a winding portion around which the wiring member is wound.
